(19) United States
(12) Patent Application Publication
(10) Pub. No.: US 2017/0130497 A1
(43) Pub. Date: May 11, 2017

(54) HINGE

(71) Applicant: Sugatsune Kogyo Co., Ltd., Tokyo (JP)

(72) Inventor: Koushi YAMAGUCHI, Tokyo (JP)

(73) Assignee: Sugatsune Kogyo Co., Ltd., Tokyo (JP)

(21) Appl. No.: 15/322,989

(22) PCT Filed: Jun. 11, 2015
(86) PCT No.: PCT/JP2015/066866

§ 371 Date: Dec. 29, 2016

(30) Foreign Application Priority Data
Jul. 3, 2014 (JP) 2014-137697

(51) Int. Cl. E05D 3/18

(52) U.S. Cl. CPC E05D 3/186; E05D 3/16

(57) ABSTRACT

Provided is a hinge capable of increasing strength. A first arm 3 has an opening 3g and is formed in a closed shape that encloses the opening 3g. A second arm 4 has a main body section 4c inserted into the opening 3g of the first arm 3 and having its height not exceeding the height of the opening 3g in the vertical direction. First and second protrusions 31 and 32 are provided that fill a gap between the main body section 4c of the second arm 4 and a second hinge main body 2, and third and fourth protrusions 33 and 34 are provided that fill a gap between the main body section 4c of the second arm 4 and a first hinge main body 1.

### TECHNICAL FIELD

The present invention relates to a hinge provided between a door and a frame to openably support the door.

### BACKGROUND ART

One type of such hinges is disclosed in Patent Document 1. As shown in FIG. 16, this hinge comprises a first hinge main body 101, which will be attached to a door, and a second hinge main body 102, which will be attached to a frame. Between the first and the second hinge main body 101 and 102, provided are a first and a second main arm 103 and 114. With the first and second hinge main bodies 101 and 102, positional adjusters 104a, 104b, 105a and 105b are assembled for performing fine-adjustment respectively to the positions of the door in vertical, horizontal and anteroposterior directions with respect to the frame.

The first arm 103 has its base end section pivotally supported by the positional adjusters 104a and 104b of the first hinge main body 101 through pivots 106a and 106b, and its fore end section pivotally and slidably supported through rotating blocks 107a and 107b by the positional adjusters 105a and 105b of the second hinge main body 102. Correspondingly, the second arm 114 has its base end section pivotally supported by the positional adjusters 105a and 105b of the second hinge main body 102 through pivots 108a and 108b, and its fore end section pivotally and slidably supported through rotating blocks 109a and 109b by the positional adjusters 104a and 104b of the first hinge main body 101.

The first arm 103 is formed into a C-shape. The second arm 114 is formed into an H-shape such that a main body section 114a extends in the horizontal direction. The main body section 114a of the second arm 114 is inserted into an opening 103a of the first arm 103 in such a way that the first arm 103 intersects with the second arm 114. The first arm 103 is rotatably coupled to the second arm 114 via arc-shaped bearings 110a and 110b. It is to be noted that in a typical hinge, the first arm 103 is pivotally coupled to the second arm 114 via a pivot instead of the arc-shaped bearings 110a and 110b (e.g. see Patent Document 2).

When the door is opening, the first arm 103 rotates with respect to the first and second hinge main bodies 101 and 102 while the second arm 114 rotates with respect to the first and second hinge main bodies 101 and 102. In addition, the first and second arms 103 and 114 rotate relatively to each other.

### PRIOR ART DOCUMENTS

### Patent Documents

Document 1: DE 102004054708 B3, and

Document 2: JP 2012-241515 A.

### SUMMARY OF THE INVENTION

### Problems to be Solved by the Invention

The first and second arms 103 and 114 of the hinge are under loads of door weight, moment and others. In a conventional hinge, the first arm 103 is formed into the C-shape so that the second arm 114 can be inserted into the first arm, which therefore causes a problem that the strength of the first arm 103 cannot be enhanced. In order to overcome such a problem, a spacer 112 is fitted in the first arm 103 after inserting the second arm 114 into an opening 103a of the first arm 103. However, that causes the spacer 112 to rattle, thus failing to enhance the strength of the first arm 103.

It is therefore an object of the present invention to solve the above-described problem and provide a hinge, of which strength can be enhanced.

### Means for Solving the Problems

The present invention will now be described. The present invention intends to provide novel configurations of a slide-type hinge and a link-type hinge. In the description, reference numerals shown in the accompanying drawings are inserted with parentheses for easier comprehension of the present invention, but are not for limiting the present invention to the illustrative embodiments.

In order to solve the above problems, an aspect of the present invention relates to a slide-type hinge, which includes a first hinge main body (1) attachable to either one of a door (d) and a frame (f), a second hinge main body (2) attachable to the other one of the door (d) and the frame (f), a first arm (3) having its base end section (3a) pivotally supported by the first hinge main body (1) and its fore end section (3b) pivotally and slidably supported by the second hinge main body (2), and a second arm (4) having its base end section (4a) pivotally supported by the second hinge main body (2) and its fore end section (4b) pivotally and slidably supported by the first hinge main body (1), wherein the first arm (3) has an opening (3g) and is formed into a single, closed piece enclosing the opening (3g), and the second arm (4) is inserted into the opening (3g) of the first arm (3) and has a main body section (4c) whose height does not exceed the height of the opening (3g) in a vertical direction, and wherein a first protrusion (31) is provided for filling a gap (61) between an upper surface of the main body section (4c) of the second arm (4) and the second hinge main body (2), a second protrusion (32) is provided for filling a gap (62) between a lower surface of the main body section (4c) of the second arm (4) and the second hinge main body (2), a third protrusion (33) is provided for filling a gap (63) between the upper surface of the main body section (4c) of the second arm (4) and the first hinge main body (1), and a fourth protrusion (34) is provided for filling a gap (54) between the lower surface of the main body section (4c) of the second arm (4) and the first hinge main body (1).

Another aspect of the present invention relates to a link-type hinge, which includes a first hinge main body (51) attachable to either one of a door (d) and a frame (f), a second hinge main body (52) attachable to the other one of the door (d) and the frame (f), a first arm (54) having its base end section (54a) pivotally supported by the first hinge main body (51) and its fore end section (54b) supported by the second hinge main body (52) via a first link (56), and a second arm (55) having its base end section (55a) pivotally supported by the second hinge main body (52) and its fore end section (55b) supported by the first hinge main body (51) via a second link (57), wherein the first arm (54) has an opening (54g) and is formed into a single, closed piece enclosing the opening (54g), the second arm (55) is inserted into the opening (54g) of the first arm (54) and has a main body section (55c) whose height does not exceed the height of the opening (54g) in a vertical direction, and wherein a first protrusion (71) is provided for filling a gap (61) between an upper surface of the main body section 55c) of the second arm (55) and the second hinge main body (52), and a second protrusion (72) is provided for filling a gap (62) between a lower surface of the main body section (55c) of the second arm (55) and the second hinge main body (52).

It is to be noted that in the present invention, the vertical direction means “upward and downward” of the door when the hinge is used to the door openable in the horizontal direction.

### Advantages of the Invention

In accordance with one aspect of the present invention, the first arm is formed into a single, dosed piece enclosing the opening, so that the strength of the first arm can be enhanced. Furthermore, even though the height of the main body section of the second arm gets lower in the vertical direction for inserting the second arm into the opening of the first arm, the first to fourth protrusions are provided to fill the gaps so as to allow the second arm to come into contact with the first and second hinge main bodies at four points in total. Thus, the second arm can bear a load stably at these four points.

In accordance with the other aspect of the present invention, the first arm is formed into a single, dosed piece enclosing the opening, so that the strength of the first arm can be enhanced. Moreover, even though the height of the main body section of the second arm gets lower in the vertical direction for inserting the second arm into the opening of the first arm, the first and second protrusions are provided to fill the gaps so as to allow the base end section of the second arm to come into contact with the second hinge main body at two points, and thereby the second arm can bear a load stably at those two points.

### BRIEF DESCRIPTION OF THE DRAWINGS

FIG. 1 is a perspective view of a hinge of a first embodiment according to the present invention;

FIG. 2 is a front view of the hinge of the first embodiment;

FIG. 3 is a cross-sectional view taken along line III-Ill of FIG. 2 (Part (b) shows the hinge when a door is at its closed position, and Part (a) shows the hinge when the door is in between its closed and open positions);

FIG. 4 is an exploded perspective view of the hinge of the first embodiment;

FIG. 5 is an enlarged perspective view of the hinge of the first embodiment;

FIG. 6 is a vertical sectional view of the hinge of the first embodiment (Part (a) shows a cross-section taken along line A-A of FIG. 2, Part (b) shows a cross-section taken along line B-B of FIG. 2, and Part (c) shows a cross-section taken along line C-C of FIG. 2);

FIG. 7 is a back side perspective view of the hinge of the first embodiment;

FIG. 8 is a schematic diagram which compares shapes of first and second arms of a conventional hinge with shapes of first and second arms of the first embodiment (Part (a) shows the conventional hinge, and Part (b) shows the hinge of the first embodiment);

FIG. 9 is a front view of alternative hinge of the first embodiment;

FIG. 10 is a perspective view of a hinge of a second embodiment according to the present invention;

FIG. 11 is a perspective view of a principal part of the hinge of the second embodiment;

FIG. 12 is a schematic diagram of a hinge of a third embodiment according to the present invention;

FIG. 13 is a front view of a hinge of a fourth embodiment according to the present invention;

FIG. 14 is a cross-sectional view taken along line XIV-XIV of FIG. 13;

FIG. 15 is an exploded perspective view of the hinge of the fourth embodiment; and

FIG. 16 is an exploded perspective view of the conventional hinge.

### MODES FOR IMPLEMENTING THE INVENTION

With reference to the accompanying drawings, preferred embodiments of a hinge according to the present invention will now be described in detail. The hinge of the present invention can be classified into a slide-type hinge (first, second and third embodiments) and a link-type hinge (fourth embodiment). Description will first be made on the slide-type hinge.

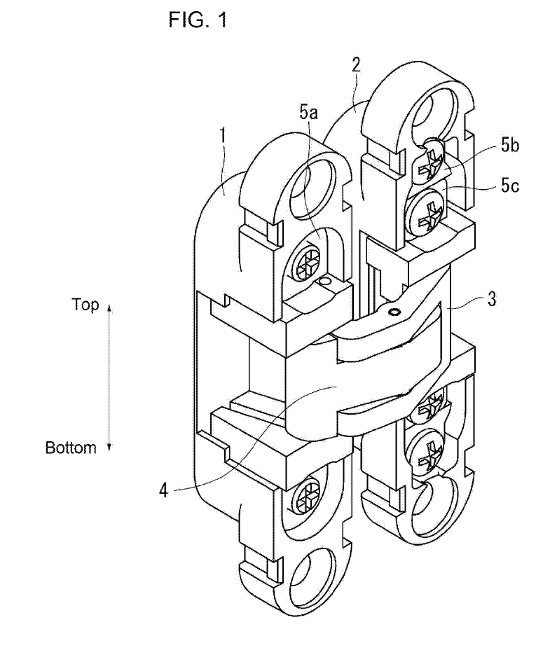

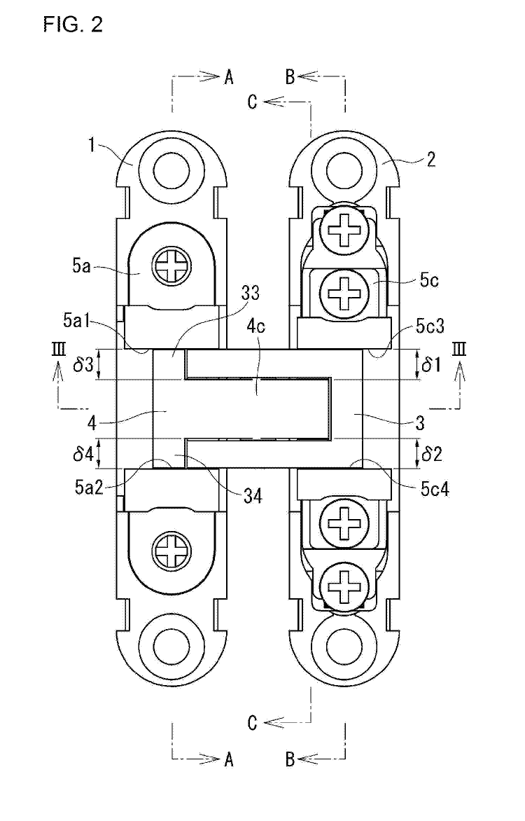

FIG. 1 shows a perspective view of a slide-type hinge of a first embodiment according to the present invention (hereinafter referred to simply as “hinge”), and FIG. 2 shows a front view of the hinge. The hinge is adapted to be used for horizontally opening and closing a door. The hinge includes a first hinge main body 1 which will be attached to either one of the door or a frame, and a second hinge main body 2 which will be attached to the other one of the door or the frame. Between the first and the hinge main body 1 and 2, a first and a second arm 3 and 4 are provided.

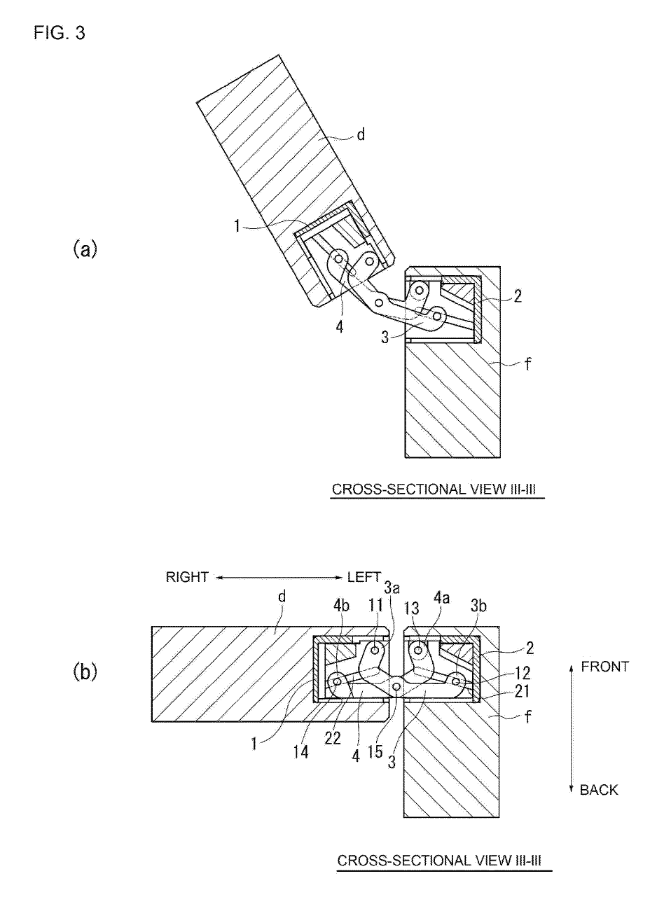

In FIG. 3, Part (a) and (b) show horizontal sectional views of the hinge. Part (b) particularly shows the hinge in a state where the door is at its closed position whereas Part (a) shows the hinge in a state where the door is in between its dosed and open positions. As shown in Part (b), the first hinge main body 1 is embedded in a cut-in part formed in the side of a door d. The second hinge main body 2 is embedded in a cut-in part formed in a frame f, facing the side of the door d. In order to prevent impairment of the design of the door d, the hinge is mounted to be invisible from outside when the door d is closed.

In the following description, the term “vertical direction” is “upward and downward” of the door d when the hinge is used to the door d that opens in the horizontal direction (see FIG. 1), and the terms “horizontal direction” and “anteroposterior direction” are directions “right and left” and “front and rear” of the door, respectively, as viewed from the front of the door d (see FIG. 3(b)).

As shown in FIG. 1, the first and second hinge main bodies 1 and 2 are provided with positional adjusters 5a to 5c for adjusting a three-dimensional position of the door d. The positional adjusters 5a to 5c are composed of a horizontal positional adjuster 5a capable of adjusting a position in the horizontal direction of the door d (see FIG. 3, Part (b)), a vertical positional adjuster 5b capable of adjusting a position in the vertical direction of the door d, and an anteroposterior positional adjuster 5c capable of adjusting a position in the anteroposterior direction of the door d (see FIG. 3, Part (b)).

As shown in FIG. 3, Part (b), the first arm 3 has its base end section 3a pivotally supported by the first hinge main body 1 via a pivot 11, and has its fore end section 3b slidably and pivotally supported by the second hinge main body 2 via a pivot 12. In the second hinge main body 2, formed is a groove 21 which allows the pivot 12 to slide therein. The second arm 4 has its base end section 4a pivotally supported by the second hinge main body 2 via a pivot 13, and has its fore end section 4b slidably and pivotally supported by the first hinge main body 1 via a pivot 14. In the first hinge main body 1, formed is a groove 22 which allows the pivot 22 to slide therein. The first arm 3 decussates with the second arm 4. Moreover, the first arum 3 is coupled to the second arm 4 such that they can pivot on a pivot 15. This hinge includes five pivots 11 to 15, of which two pivots 12 and 14 can slide with respect to the first and second hinge main bodies 1 and 2.

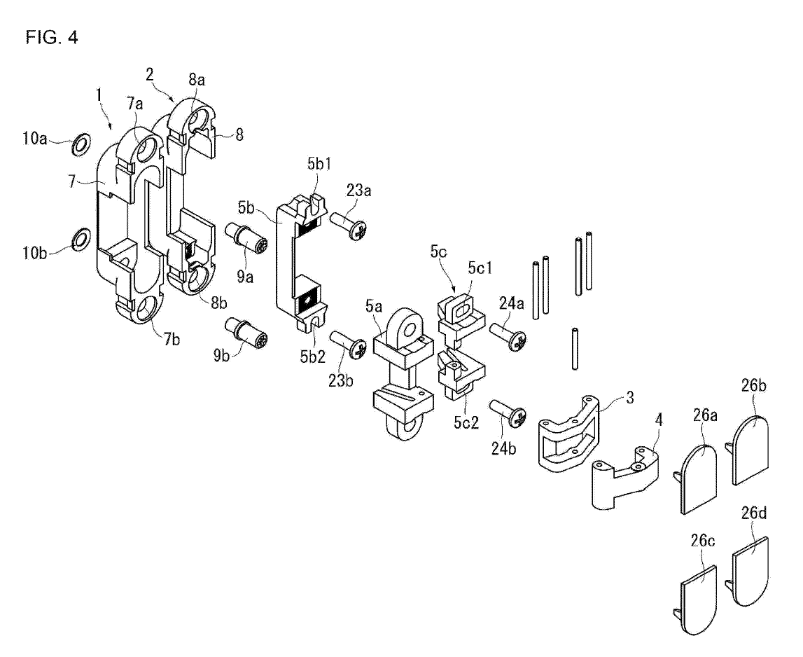

FIG. 4 shows an exploded perspective view of the hinge. As described above, the hinge includes the first and second hinge main bodies 1 and 2, and the first and second arms 3 and 4. In the following, those components will be described in turn.

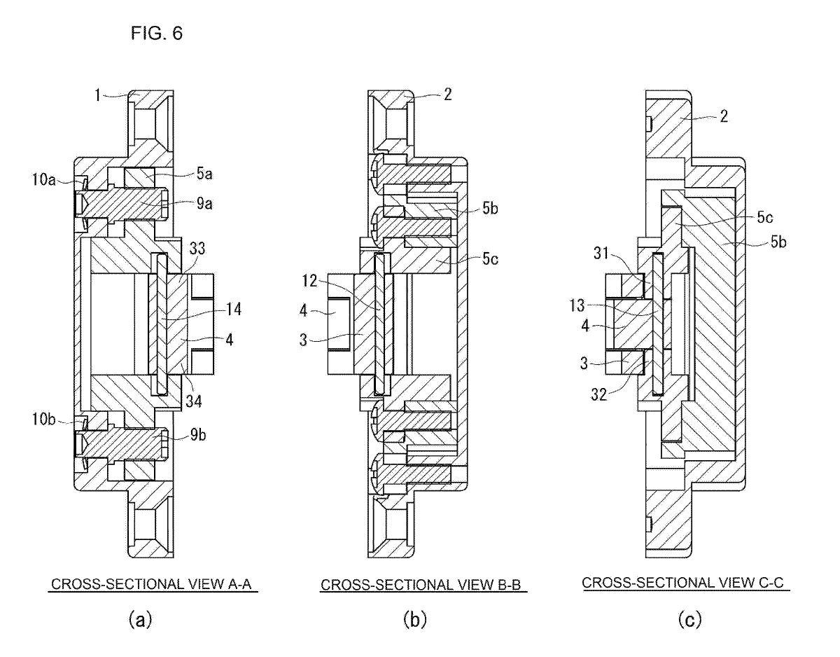

The first hinge main body 1 includes a base frame 7 to be attached to the door d, and the horizontal positional adjuster 5a capable of positional adjustment relative to the base frame 7. Formed in the base frame 7 are through holes 7a and 7b for introducing attachment screws, not shown, for mounting the base frame 7 on the door d. To the base frame 7, horizontal adjustment screws 9a and 9b are attached pivotally but axially-immovably (see also the cross-sectional view in FIG. 6, Part (a)). The tip parts of the horizontal adjustment screws 9a and 9b are respectively provided with washers 10a and 10b for preventing the slip off of the horizontal adjustment screws 9a and 9b. The horizontal adjustment screws 9a and 9b threadedly engage with the horizontal positional adjuster 5a. When the horizontal adjustment screws 9a and 9b are turned, the horizontal positional adjuster 5a is pushed up from or into the base frame 7. It allows the positional adjustment of the door d in the horizontal direction. If the positional adjustment function is not required, the horizontal positional adjuster 5a can be integrated into the base frame 7.

The second hinge main body 2 includes a base frame 8 which will be attached to a frame f the vertical positional adjuster 5b capable of positional adjustment in the vertical direction with respect to the base frame 8, and the anteroposterior positional adjuster 5c capable of positional adjustment in the horizontal direction with respect to the vertical positional adjuster 5b (anteroposterior direction in FIG. 3, Part (b)). in the base frame 8, through holes 8a and 8b are formed for introducing attachment screws, not shown, for mounting the base frame 8 on the frame f The vertical positional adjuster 5b is provided with elongate holes 5b1 and 5b2 extending in the vertical direction. The elongate holes 5b1 and 5b2 are for introducing therethrough screws 23a and 23b for attaching the vertical positional adjuster 5b to the base frame 8. The vertical positional adjuster 5b can perform the positional adjustment in the vertical direction over the lengths of the elongate holes 5b1 and 5b2. The anteroposterior positional adjuster 5c is provided with elongate holes 5c1 and 5c2 extending in the horizontal direction. The elongate holes 5c1, 5c2 are for introducing therethrough screws 24a and 24b for attaching the anteroposterior positional adjuster 5c to the vertical positional adjuster 5b. The anteroposterior positional adjuster 5c can perform the positional adjustment in the horizontal direction over the lengths of the elongate holes 5c1 and 5c2. The anteroposterior positional adjuster 5c is separated into upper and lower parts so as to be readily formable.

The base frames 7 and 8 are made of metal. Furthermore, the positional adjusters 5a to 5c are made of resin or metal. The positional adjusters 5a to 5c in this embodiment are preferably made of metal if the hinge is upsized. After the positional adjustment, the base frames 7 and 8 are covered with screw covers 26a to 26d.

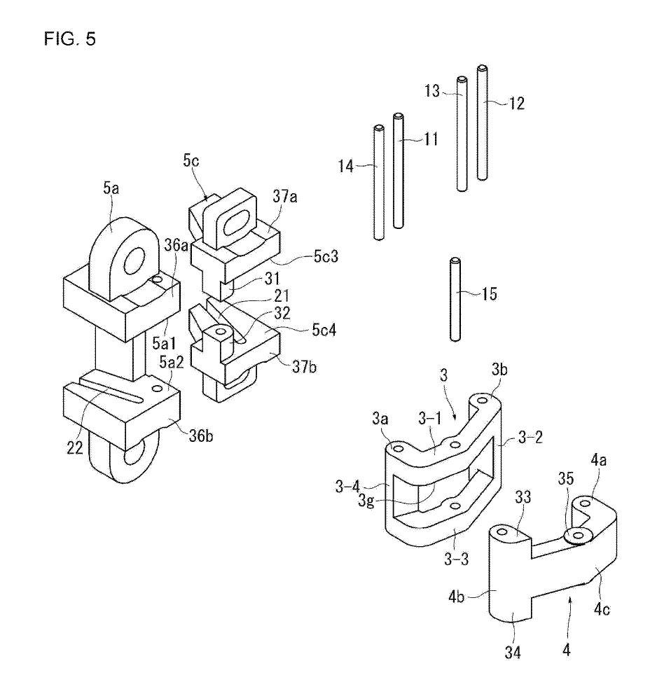

FIG. 5 is an enlarged view showing the first and second arms 3 and 4, the horizontal positional adjuster 5a, and the anteroposterior positional adjuster 5c. The first arm 3 is formed into a curved square frame shape. The first arm 3 has an opening 3g. The first arm 3 is formed into a single, closed piece enclosing the opening 3g. More specifically, the first arm 3 consists of a top part 3-1, a side part 3-2, a bottom part 3-3 and another side part 3-4, which surround together the opening 3g and are continuously formed. The first arm 3 may be configured of two parts as long as the arm has its portion formed into a single, closed structure.

As described above, the first arm 3 has its base end section 3a pivotally supported by the horizontal positional adjuster 5a via the pivot 11, and also has its fore end section 3b pivotally and slidably supported by the anteroposterior positional adjuster 5c via the pivot 12. The base end section 3a of the first arm 3 is caught by a pair of guide surfaces 5a1 and 5a2 of the horizontal positional adjuster 5a, and the base end section 3a comes into contact with the horizontal positional adjuster 5a at its two, upper and lower, points. The fore end section 3b of the first arm 3 is caught by a pair of guide surfaces 5c3 and 5c4 of the anteroposterior positional adjuster 5c, and the fore end section 3b of the first arm 3 comes into contact with the anteroposterior positional adjuster 5c at its two, upper and lower, points. Thus, the first arm 3 can bear the load stably at the entire, four points. The pivots 11 and 12 may be inserted in the base end section 3a and the fore end section 3b of the first arm 3 to thereby bear the load also with the pivots 11 and 12. Nevertheless, the contact points between the first arm 3 and the guide surfaces 5a1, 5a2 and 5c3, 5c4 mainly bear the load.

The second arm 4 is formed into a curved T-shape. The second arm 4 has a main body section 4c inserted into the opening 3g of the first arm 3. The main body section 4c extends in the horizontal direction. The main body section 4c has its height not exceeding the height in the vertical direction of the opening 3g. The second arm 4 thus inserted into the opening 3g of the first arm 3 is pivotally coupled to the first arm 3 through a pivot 15.

As described above, the second arm 4 has its base end section 4a pivotally supported by the anteroposterior positional adjuster 5c via the pivot 13, and has its fore end section 4b pivotally and slidably supported by the horizontal positional adjuster 5a via the pivot 14. The height of the main body section 4c of the second arm 4 is lower than that of the first arm 3. As a consequence, a gap 51 is produced between the upper surface of the main body section 4c of the second arm 4 and the guide surface 5c3 of the anteroposterior positional adjuster 5c (see FIG. 2), and a gap 52 is produced between the lower surface of the main body section 4c of the second arm 4 and the guide surface 5c4 of the anteroposterior positional adjuster 5c (see FIG. 2). Correspondingly, a gap 53 is produced between the upper surface of the main body section 4c of the second arm 4 and the guide surface 5a1 of the horizontal positional adjuster 5a (see FIG. 2), and a gap 54 is produced between the lower surface of the main body section 4c of the second arm 4 and the guide surface 5a2 of the horizontal positional adjuster 5a (see FIG. 2).

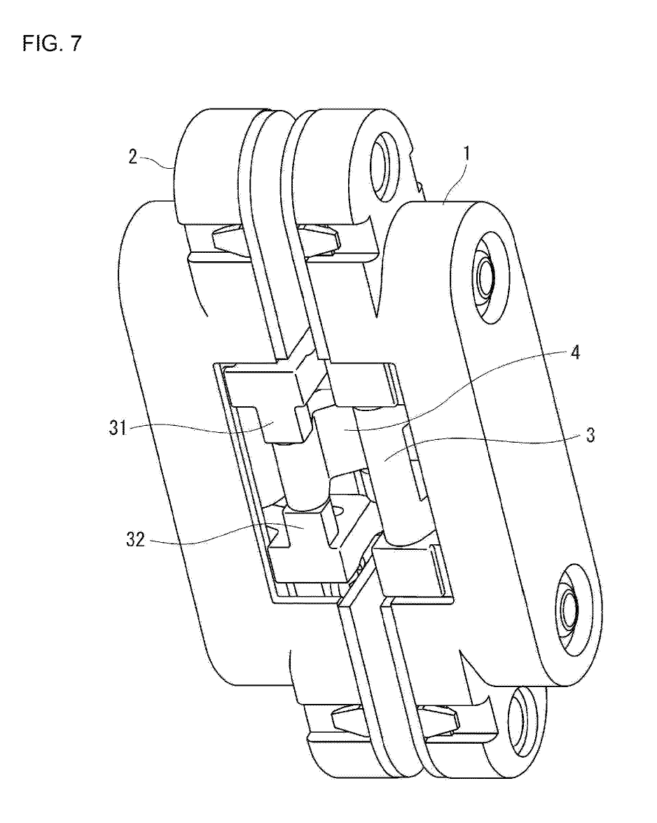

The presence of the gaps 51 to 54 impairs the stable load-bearing by the second arm 4. As shown in FIG. 5, a first protrusion 31 is provided to fill the gap 51 and a second protrusion 32 is provided to fill the gap 52 (regarding the first and second protrusions 31 and 32, see FIG. 6, Part (c), showing a cross-sectional view taken along a line C-C in FIG. 2, and FIG. 7 showing a perspective view of the back side of the hinge). In addition, a third protrusion 33 is provided to fill the gap 53 and a fourth protrusion 34 is provided to fill the gap 54 (regarding the third and fourth protrusions 33 and 34, see FIG. 2 as well as FIG. 6, Part (a), showing a cross-sectional view taken along the line A-A in FIG. 2).

The first to fourth protrusions 31 to 34 can be disposed on the second arm 4 or on the horizontal positional adjuster 5a and the anteroposterior positional adjuster 5c. In this embodiment, the first and second protrusions 31 and 32 are disposed on the anteroposterior positional adjuster 5c, and the third and fourth protrusions 33 and 34 are disposed on the second arm 4. It facilitates the insertion of the second arm 4 into the opening 3g of the first arm 3, and can prevent the interference of the third and fourth protrusions 33 and 34 with the first arm 3.

It is to be noted that pivots 13 and 14 are inserted into the base end section 4a and the fore end section 4b of the second arm 4, thereby enabling to receive the load. Nevertheless, the load is received mainly by the contact points of the base end section 4a of the second arm 4 and the second protrusions 31, 32 as well as the contact points of the third and fourth protrusions 33, 34 on the fore end section 4b of the second arm 4 and the guide surfaces 5a1, 5a2 of the horizontal positional adjuster 5a. To be exact, most of the entire part of the main body section 4c of the second arm 4 is inserted into the opening 3g of the first arm 3 while the base part of the main body section 4c of the second arm 4 is not inserted into the opening 3g. On this base part of the main body section 4c of the second arm 4, the third and fourth protrusions 33, 34 are disposed.

As shown in FIG. 5, both of the first and second arms 3 and 4 are formed of metal. For keeping those metals from touching to each other, a spacer 35 made of resin is disposed between the first and second arms 3 and 4.

Now, a description will be made on the configurations of the horizontal and anteroposterior positional adjusters 5a and 5c. As shown in FIG. 5, the horizontal positional adjuster 5a includes a pair of generally rectangular upper and lower supporting sections 36a and 36b. The pair of supporting sections 36a and 36b has a pair of guide surfaces 5a1 and 5a2 opposed in parallel to each other. The pair of guide surfaces 5a1 and 5a2 holds therebetween the base end section 3a of the first arm 3 and the fore end section 4b of the second arm 4. The pivot 11 acting as the center of rotation of the base end section 3a of the first arm 3 penetrates the pair of supporting section 36a and 36b, and the first arm 3. The base end section 3a of the first arm 3 pivots on the pivot 11 while contacting with the pair of guide surfaces 5a1 and 5a2. Similarly, the pivot 14 as the center of rotation of the second arm 4 penetrates the fore end section 4b of the second arm 4. The pair of guide surfaces 5a1 and 5a2 is provided with grooves 22, into which the opposite ends of the pivot 14 are engaged. On the fore end section 4b of the second arm 4, the third and fourth protrusions 33 and 34 are integrally formed. Thus, the number of parts can be reduced, and thereby the assemblability can be improved. The fore end section 4b of the second arm 4 pivots on the pivot 14 with the guidance of the pair of guide surfaces 5a1 and 5a2 while sliding along the grooves 22.

The anteroposterior positional adjuster 5c also includes a pair of generally rectangular upper and lower supporting sections 37a and 37b. The pair of supporting sections 37a and 37b has a pair of guide surfaces 5c3 and 5c4 opposed in parallel to each other. The pair of guide surfaces 5c3 and 5c4 holds therebetween the fore end section 3b of the first arm 3. Protruding through the pair of guide surfaces 5c3 and 5c4 are the first and second protrusions 31 and 32. The base end section 4a of the second arm 4 is caught by the first and second protrusions 31 and 32. The pivot 13 as the center of rotation of the base end section 4a of the second arm 4 penetrates the base end section 4a of the second arm 4. The pivot 13 has its opposite ends respectively inserted into holes formed in the first and second protrusions 31 and 32. The base end section 4a of the second arm 4 pivots on the pivot 13 while contacting with the first and second protrusions 31 and 32. The first and second protrusions 31 and 32 are formed integrally with the anteroposterior positional adjuster 5c. Thus, the number of parts can be reduced, and thereby the assemblability can be improved. Similarly, the pivot 12 as the center of rotation of the fore end section 3b of the first arm 3 penetrates the fore end section 3b of the first arm 3. The pair of guide surfaces 5c3 and 5c4 is provided with grooves 21, into which the opposite ends of the pivot 12 are engaged. The fore end section 3b of the first arm 3 pivots on the pivot 12 with the guidance of the pair of guide surfaces 5c3 and 5c4 while sliding along the grooves 21.

It is to be noted that in this embodiment, the anteroposterior positional adjuster 5c is separated into upper and lower elements, in which the first protrusion 31 is formed integral with the upper divided element and the second protrusion 32 is formed integral with the lower divided element. In any case, the first and second protrusions 31 and 32 are formed integral with the anteroposterior positional adjuster 5c.

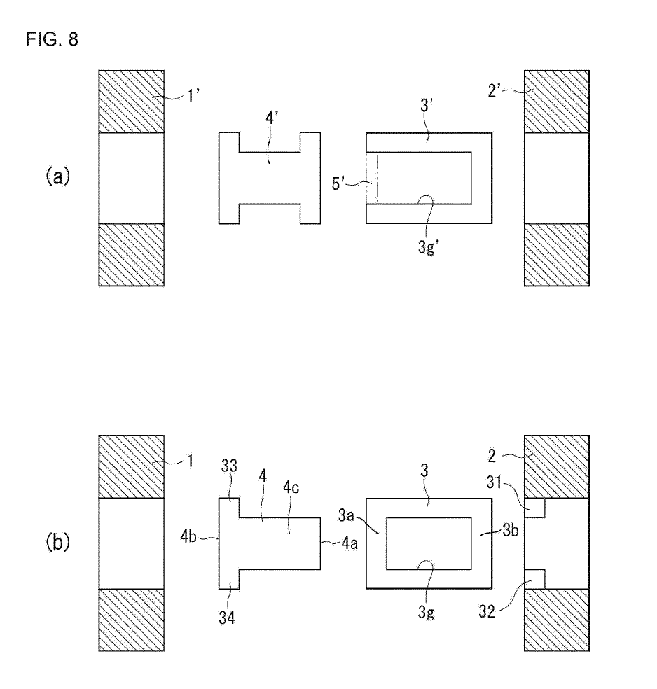

FIG. 8 is a schematic diagram comparing the shapes of the first and second arms 3′ and 4′ of a conventional hinge with the shapes of first and second arms 3 and 4 of this embodiment. As shown in FIG. 8, Part (a), the first arm 3′ of the conventional hinge is formed into a C-shape so that the second arm 4′ can be inserted into an opening 3g′ of the first arm 3′. Consequently, the strength of the first arm 3′ cannot be enhanced. Even though a spacer 5′ is fitted in the first arm 3′ after inserting the second arm 4′, the first arm 3′ will not be strengthen due to the rattle of the spacer 5′.

By contrast, as shown in FIG. 8, Part (b), the first arm 3 of the hinge of this embodiment is formed into a closed shape enclosing the opening 3g, thereby enabling to enhance the strength of the first arm 3. In order to insert the second arm 4 into the opening 3g of the first arm 3, the height in the vertical direction of the main body section 4c of the second arm 4 should be made lower. However, since the second hinge main body 2 is provided with the first and second protrusions 31 and 32, the gap between the base end section 4a of the second arm 4 and the second hinge main body 2 can be filled. Moreover, the fore end section 4b of the second arm 4 is provided with the third and fourth protrusions 33 and 34, which can fill the gap between the fore end section 4b of the second arm 4 and the first hinge main body 1.

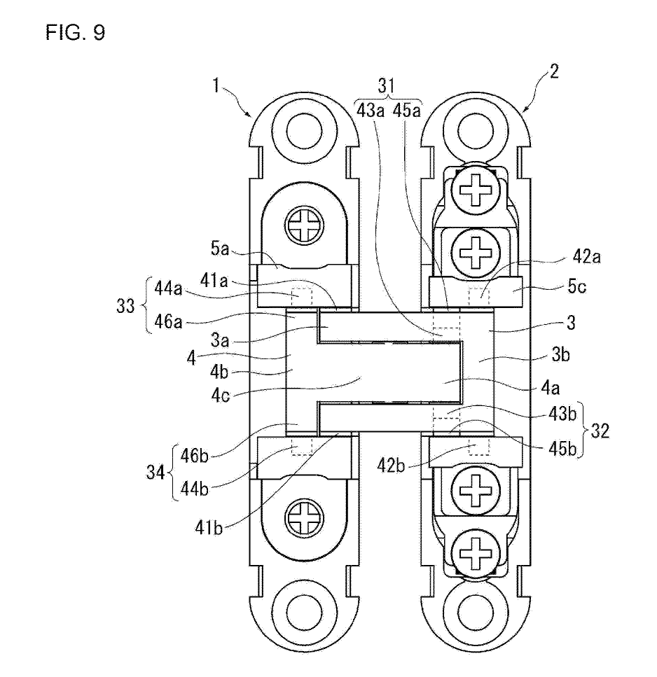

FIG. 9 shows another example of the hinge of this embodiment. The hinge of this example is for a heavy door, in which hinge the horizontal positional adjuster 5a and the anteroposterior positional adjuster 5c are made of metal. In order to avoid those metals from touching to each other, the base end section 3a of the first arm 3 and the horizontal positional adjuster 5a are provided therebetween with bushes, or spacers, 41a and 41b whereas the fore end section 3b of the first arm 3 and the anteroposterior positional adjuster 5c are provided therebetween with rotating blocks 42a and 42b. In addition, the base end section 4a of the second arm 4 and the anteroposterior positional adjuster 5c are provided therebetween with bushes 43a, 43b, or spacers, whereas the fore end section 4b of the second arm 4 and the horizontal positional adjuster 5a are provided therebetween with rotating blocks 44a and 44b. The respective shapes of the first and second arms 3 and 4, the horizontal positional adjuster 5a, and the anteroposterior positional adjuster 5c are almost the same as the hinge of the first embodiment.

The rotating blocks 42a and 42b of the fore end section 3b of the first arm 3 are rotatable with respect to the first arm 3, and are slidably fitted in the grooves 21 of the anteroposterior positional adjuster 5c (see FIG. 5). The rotating blocks 44a and 44b of the fore end section 4b of the second arm 4 are rotatable with respect to the second arm 4, and are slidably fitted in the grooves 22 of the horizontal positional adjuster 5a (see FIG. 5). In the illustrative example, the first and second protrusions 31 and 32 are composed of first and second protruding main bodies 45a and 45b formed integral with the anteroposterior positional adjuster 5c, and the bushes 43a and 43b. To the anteroposterior positional adjuster 5c, some of a part of the first protrusion 31, namely the first protruding main body 45a, and a part of the second protrusion 32, namely the second protruding main body 45b, are integrally formed. Furthermore, the third and fourth protrusions 33 and 34 are composed of third and fourth protruding main bodies 46a and 46b formed integral with the second arm 4, and the rotating blocks 44a and 44b. To the second arm 4, a part of the third protrusion 33, namely the third protruding main body 46a, and a part of the fourth protrusion 34, namely the fourth protruding main body 46b, are integrally formed.

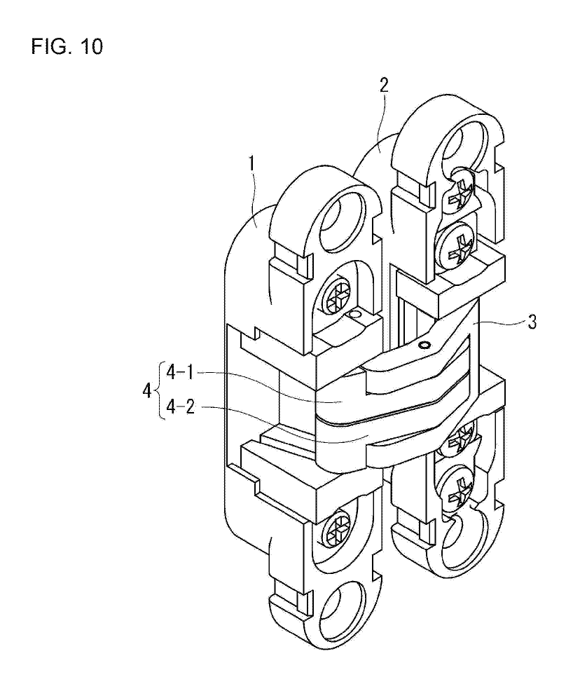

FIG. 10 shows a perspective view of a hinge of a second embodiment according to the present invention. The hinge of this embodiment is similar to that of the first embodiment, except that the second arm 4 consists of an upper and a lower second arm 4-1 and 4-2 which are separated in the vertical direction. Since the configurations of the first arm 3, the first and second hinge main bodies 1 and 2 are almost the same as the hinge of the first embodiment, the same reference numerals are allotted to avoid repetitive description thereon.

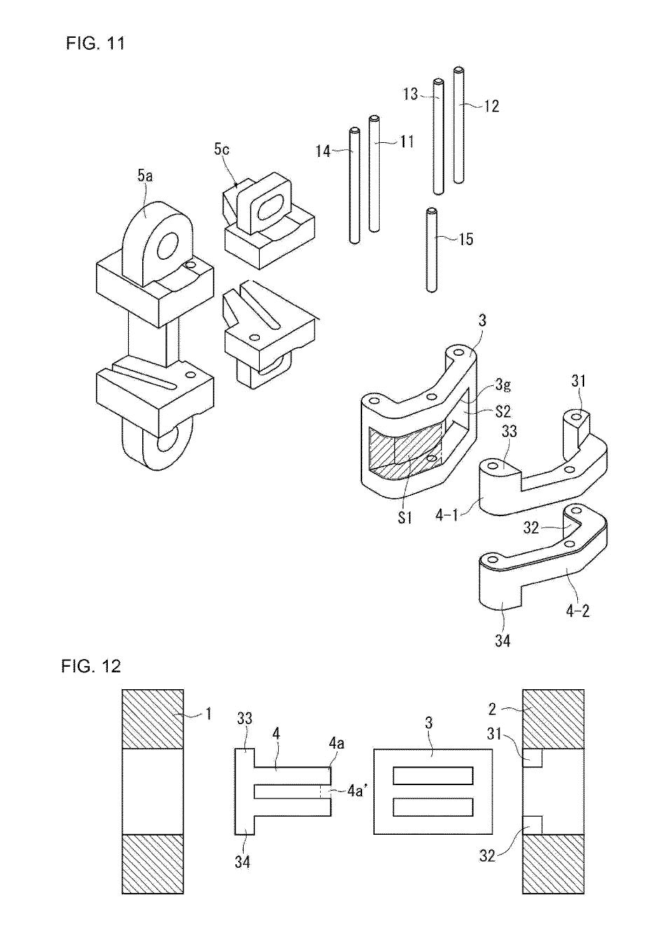

FIG. 11 is a perspective view showing a principal part of the hinge of the second embodiment. The first and second protrusions 31 and 32 in the first embodiment are formed integral with the anteroposterior positional adjuster 5c whereas the first protrusion 31 of this embodiment is formed integral with the upper second arm 4-1 and the second protrusion 32 is formed integral with the lower second arm 4-2. Moreover, the third protrusion 33 is formed integral with the upper second arm 4-1 while the fourth protrusion 34 is formed integral with the lower second arm 4-2. The height from the lower surface of the upper second arm 4-1 to the upper surfaces of the first and third protrusions 31 and 33 does not exceed the height of the opening 3g of the first arm 3 in the vertical direction. The height from the upper surface of the lower second arm 4-2 to the lower surfaces of the second and fourth protrusions 32 and 34 does not exceed the height of the opening 3g of the first arm 3 in the vertical direction.

It is to be noted that between the upper second arm 4-1 and the first hinge main body 1 and between the upper second arm 4-1 and the second hinge main body 2, spacers may be provided. In this case, at least a part of the first protrusion 31 and at least a part of the third protrusion 33 are formed integral with the upper second arm 4-1. Also, between the lower second arm 4-2 and the first hinge main body 1 and between the lower second arm 4-2 and the second hinge main body 2, spacers may be provided. In this case, at least a part of the second protrusion 32 and at least a part of the fourth protrusion 34 are formed integral with the lower second arm 4-2.

After the insertion of the upper second arm 4-1 into the opening 3g of the first arm 3, the upper second arm 4-1 is pushed over to an area S1 depicted with oblique lines in FIG. 11 so as to allow the lower second arm 4-2 to be inserted into the other area S2 of the opening 3g afterward. In this way, vertically dividing the second arm 4 into two portions permits the second arm 4 to be inserted into the opening 3g of the first arm 3.

FIG. 12 is a schematic diagram showing a hinge of a third embodiment according to the present invention. In the hinges of the above-described first and second embodiments, the first arm 3 is formed into the square frame shape and the second arm 4 is formed in the T-shape. Alternatively, as shown in FIG. 12, the first arm 3 may be formed in a 8-shape and the second arm 4 may be formed in a 7-shape put in a sideways position. In this case, the first and second protrusions 31 and 32 are disposed on the second hinge main body 2. The third and fourth protrusions 33 and 34 are disposed on the second arm 4. Into the base end section 4a of the second arm 4 is inserted a spacer 4a′. Since the height of the spacer 4a′ can be made lower than that of the spacer of the conventional hinge, the strength of the second arm 4 does not decrease as much as that of the conventional hinge.

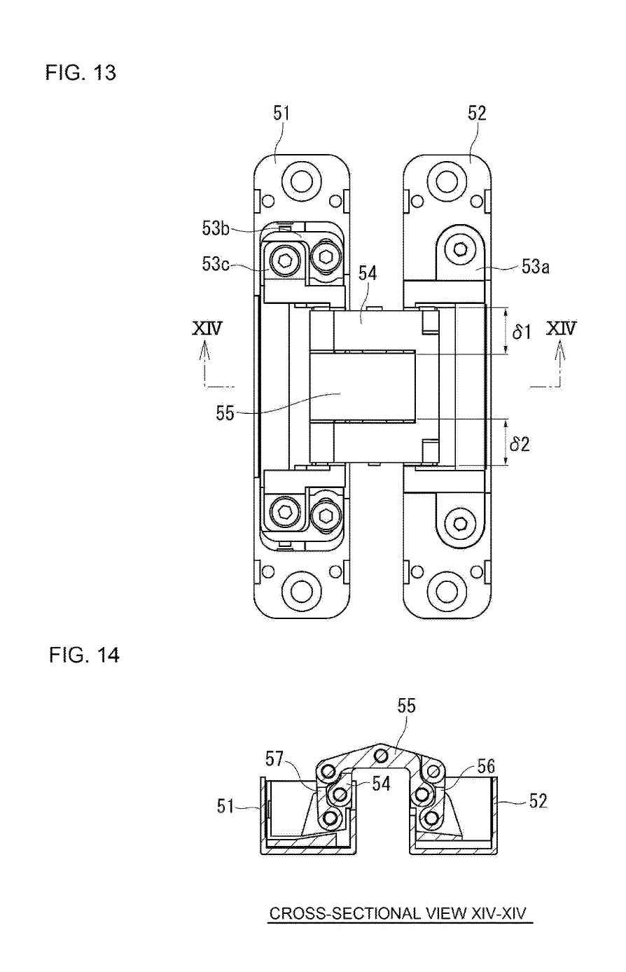

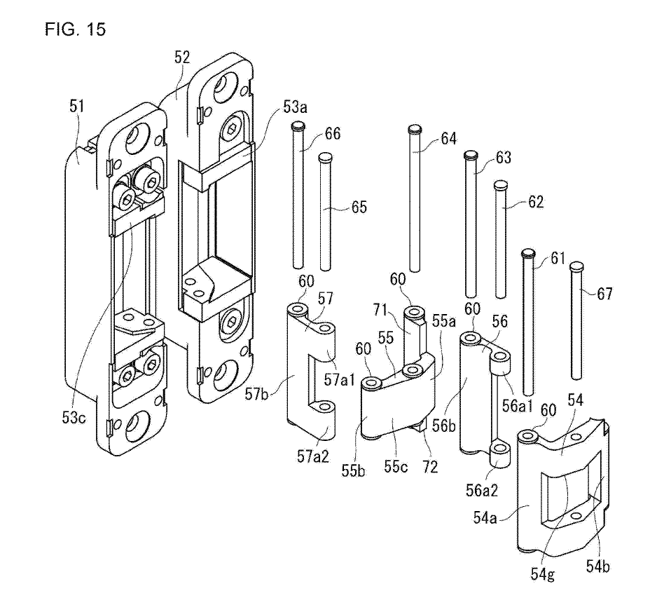

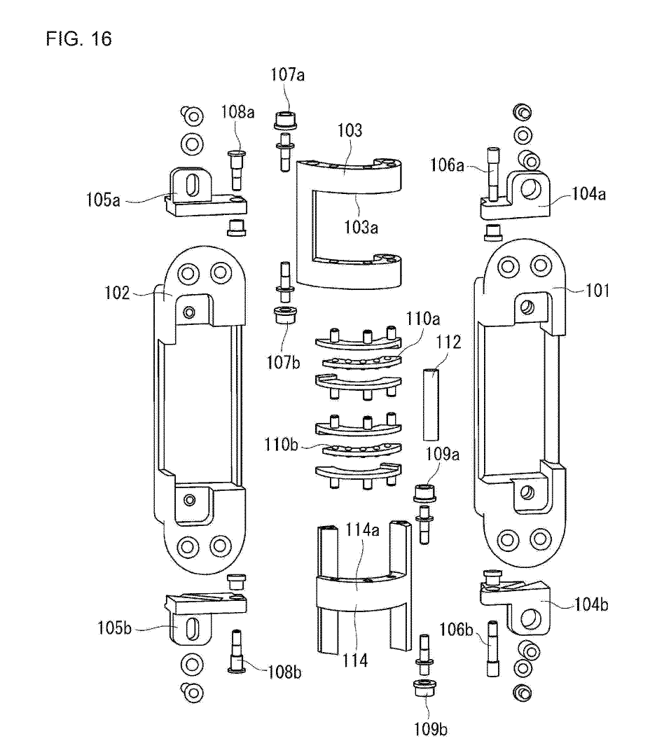

FIGS. 13 to 15 show a hinge of a fourth embodiment according to the present invention. FIG. 13 is a front view, FIG. 14 is a cross-sectional view taken along a XIV-XIV line in FIG. 13, and FIG. 15 is an exploded perspective view of the hinge. The hinge of the fourth embodiment is a link-type hinge (hereinafter referred to simply as “hinge”), and includes a first hinge main body 51 attachable to either one of a door and a frame, and a second hinge main body 52 attachable to the other one of the door and the frame. The first and second hinge main bodies 51 and 52 are provided with positional adjusters 53a to 53c for adjusting a three-dimensional position of the door. The positional adjusters 53a to 53c consist of a horizontal positional adjuster 53a capable of adjusting a position in the horizontal direction of the door, a vertical positional adjuster 53b capable of adjusting a position in the vertical direction of the door and an anteroposterior positional adjuster 53c capable of adjusting a position in the anteroposterior direction of the door.

As shown in FIG. 15, the hinge includes seven pivots 61 to 67 in total for coupling first and second hinge main bodies 51 and 52, first and second arms 54 and 55, and first and second links 56 and 57 in a turning-contraposition manner. More specifically, the anteroposterior positional adjuster 53c of the first hinge main body 51 pivotally supports a base end section 54a of the first arm 54 via the pivot 61. To a fore end section 54b of the first arm 54, pivotally coupled are base end sections 56a1 and 56a2 of the first link 56 via the pivot 62. The first link 56 has its fore end section 56b pivotally supported by the horizontal positional adjuster 53a of the second hinge main body 52 via the pivot 63.

Furthermore, the horizontal positional adjuster 53a of the second hinge main body 52 pivotally supports a base end section 55a of the second arm 55 via the pivot 64. To a fore end section 55b of the second arm 55, pivotally coupled are base end section 57a1 and 57a2 of the second link 57 via the pivot 65. The second link 57 has its fore end section 57b pivotally supported by the anteroposterior positional adjuster 53c of the first hinge main body 51 via the pivot 66. In this embodiment, the first and second hinge main bodies 51 and 52, the first and second arms 54 and 55, and the first and second links 56 and 57 are made of metal. For keeping the metals from touching to each other, the above-mentioned elements are provided with resin spacers 60 in between.

The first arm 54 is formed into a curved square frame shape. The first arm 54 has an opening 54g. The first arm 54 is formed into a single, closed piece enclosing the opening 54g.

The first link 56 bifurcates into the first and second base end sections 56a1 and 56a2 for holding therebetween the fore end section 54b of the first arm 54. The fore end section 54b of the first arm 54 is pivotally coupled to the first and second base end sections 56a1 and 56a2 via the pivot 62.

The second arm 55 is formed into the curved T-shape. The second arm 55 has a main body section 55c to be inserted in the opening 54g of the first arm 54. The main body section 55c extends in the horizontal direction. The main body section 55c has its height not exceeding that of the opening 54g in the vertical direction. The second arm 55 inserted in the opening 54g is pivotally coupled to the first arm 54 through the pivot 67.

The second link 57 bifurcates into the first and second base end sections 57a1 and 57a2 for holding therebetween the main body section 55c of the second arm 55 in the vertical direction. The fore end section 55b of the second arm 55 is pivotally coupled to the first and second base end sections 57a1 and 57a2 of the second link 57 via the pivot 65.

The height of the main body section 55c of the second arm 55 is lower than the height of the first arm 54. As a consequence, between the upper surface of the main body section 55c of the second arm 55 and the horizontal positional adjuster 53a of the second hinge main body 52, a gap 51 is produced (see FIG. 13), and between the lower surface of the main body section 55c of the second arm 55 and the horizontal positional adjuster 53a of the second hinge main body 52 is produced a gap 52 (see FIG. 13). The presence of the gaps 51 and 52 impairs the stable load bearing of the second arm 55. As shown in FIG. 15, a first protrusion 71 is provided to fill the gap 51, and a second protrusion 72 is provided to fill the gap 52. The first and second protrusions 71 and 72 are formed integral with the second arm 55.

It would be appreciated that the shapes and configurations of the hinges according to the first to fourth embodiments are illustrative only, and thus the hinges can adopt other shapes and configurations without changing the gist of the present invention.

The first and second arms are pivotally coupled to each other via the pivot in the first to fourth embodiments, but also can be pivotally coupled via an arc-shaped bearing.

This specification is made based on Japanese patent application No. 2014-137697 filed on Jul. 3, 2014. The disclosure thereof is incorporated herein by reference in its entirety.

### LIST OF REFERENCE NUMERALS

1. First Hinge Main Body
2. Second Hinge Main Body
3. First Arm
3a. Base End Section of First Arm
3b. Fore End Section of First Arm
3g. Opening of First Arm
4. Second Arm
4-1. Upper Second Arm
4-2. Lower Second Arm
4a. Base End Section of Second Arm
4b. Fore End Section of Second Arm
4c. Main Body Section of Second Arm
5a. Horizontal Positional adjuster (Positional adjuster)
5b. Vertical Positional adjuster (Positional adjuster)
5c. Anteroposterior Positional adjuster (Positional adjuster)
7, 8. Base Frame
31. First Protrusion
32. Second Protrusion
33. Third Protrusion
34. Fourth Protrusion
51. First Hinge Main Body
52. Second Hinge Main Body
53a. Horizontal Positional adjuster (Positional adjuster)
53b. Vertical Positional adjuster (Positional adjuster)
53c. Anteroposterior Positional adjuster (Positional adjuster)
54. First Arm
54a. Base End Section of First Arm
54b. Fore End Section of First Arm
54g. Opening of First Arm
55. Second Arm
55a. Base End Section of Second Arm
55b. Fore End Section of Second Arm
55c. Main Body Section of Second Arm
56. First Link
57. Second Link
71. First Protrusion
72. Second Protrusion

1. A hinge comprising:
a first hinge main body attachable to either one of a door and a frame;
a second hinge main body attachable to another one of the door and the frame;
a first arm having a base end section pivotally supported by the first hinge main body and a fore end section pivotally and slidably supported by the second hinge main body; and
a second arm having a base end section pivotally supported by the second hinge main body and a fore end section pivotally and slidably supported by the first hinge main body,
wherein the first arm has an opening and is formed in a single, closed piece enclosing the opening,
the second arm being inserted into the opening of the first arm, and having a main body section whose height does not exceed a height of the opening in a vertical direction, and
wherein a first protrusion is provided for filling a gap between an upper surface of the main body section of the second arm and the second hinge main body, a second protrusion is provided for filling a gap between a lower surface of the main body section of the second arm and the second hinge main body, a third protrusion is provided for filling a gap between the upper surface of the main body section of the second arm and the first hinge main body, and a fourth protrusion is provided for filling a gap between the lower surface of the main body section of the second arm and the first hinge main body.

2. The hinge in accordance with claim 1, wherein the first and second protrusions are disposed on the second hinge main body, and
the third and fourth protrusions are disposed on the second arm.

3. The hinge in accordance with claim 2, wherein the second hinge main body comprises a base frame attachable to either one of the door and the frame, and a positional adjuster capable of positional adjustment with respect to the base frame, and
at least a part of the first protrusion and at least a part of the second protrusion are formed integral with the positional adjuster of the second hinge main body.

4. The hinge in accordance with claim 2 or 3, wherein at least a part of the third protrusion and at least a part of the fourth protrusion are formed integral with the second arm.

5. The hinge in accordance with claim 1, wherein the second arm comprises an upper second arm and a lower second arm separated from each other in the vertical direction,
at least a part of the first protrusion and at least a part of the third protrusion are formed integral with the upper second arm, and
at least a part of the second protrusion and at least a part of the fourth protrusion are formed integral with the lower second arm.

6. A hinge comprising:
a first hinge main body attachable to either one of a door and a frame;
a second hinge main body attachable to another one of the door and the frame;
a first arm having a base end section pivotally supported by the first hinge main body and a fore end section supported by the second hinge main body via a first link; and
a second arm having a base end section pivotally supported by the second hinge main body and a fore end section supported by the first hinge main body via a second link,
wherein the first arm has an opening and is formed in a single, closed piece enclosing the opening,
the second arm being inserted into the opening of the first arm, and having a main body section whose height does not exceed a height of the opening in a vertical direction, and
wherein a first protrusion is provided for filling a gap between an upper surface of the main body section of the second arm and the second hinge main body, and a second protrusion is provided for filling a gap between a lower surface of the main body section of the second arm and the second hinge main body.
